(19) United States
(12) Patent Application Publication
(10) Pub. No.: US 2006/0150834 A1
(43) Pub. Date: Jul. 13, 2006

(54) Screen printing machine

(75) Inventor: Dietmar Weber, Reute (DE)

Correspondence Address: CROWELL & MORING LLP;INTELLECTUAL PROPERTY GROUP, P.O. BOX 14300, WASHINGTON, DC, 20044-4300, US

(73) Assignee: Thieme GmbH & Co. KG, Teningen (DE)

(21) Appl. No.: 10/536,796

(22) PCT Filed: Oct. 16, 2003
(86) PCT No.: PCT/EP03/11474

§ 371 Date: Mar. 3, 2006

(30) Foreign Application Priority Data
Nov. 27, 2002 (DE) 102 56 327.6

(51) Int. Cl. B05C 17/08

(52) U.S. Cl. 101/126

(57) ABSTRACT

The invention relates to a screen-printing machine which comprises a gripping mechanism connected to a printing board used for inputting and outputting a printed article. Said gripping mechanism is provided several grippers which are disposed on a conveyor belt. A flexible and flat support preferably made of fabric is arranged between each pair of grippers. The printed article is placed on the support when it is transferred over the printing board. Said invention prevents the rear face of the printed article from being damaged.

This application is a national phase of International application PCT/EP2003/011475, filed Oct. 16, 2003 and claims the priority of German application No. 102 56 326.8, filed Nov. 27, 2002, the disclosure of which are expressly incorporated by reference herein.

### BACKGROUND AND SUMMARY OF THE INVENTION

The invention relates to a screen printing machine having a gripper mechanism assigned to the print table for conveying the print material into and out of the machine.

Screen printing machines of this type are known. They are usually equipped with a peripheral gripper system and may be designed as single-color or multicolor printing machines. The print material is conveyed by the grippers from one side into the machine, where it is printed and conveyed back out again on the other side. In doing so, the back side of the print material slides over support plates and over the print table and dryer table. This can result in damage, e.g., in the form of scratches on the back surface, which can result in considerable quality deficiencies in the case of transparent materials or materials already printed on the back side.

It is already known that the surface of the print table over which the material slides may be coated or it is also possible to work with blowing air support in the area of the print table, to achieve an improvement here. However, it has been found that the problem defined above can be solved only inadequately by this method.

Therefore the object of the present invention is to design a screen printing machine of the type defined in the preamble so that damage to the back side of the print material is prevented.

To achieve this object, it is proposed that with a screen printing machine of the type defined in the preamble, a flexible and flat carrier on which the print material rests is connected to the gripper mechanism.

The print material to be conveyed continuously lies on the carrier in this way in conveyance through the screen printing machine and does not come in direct contact with either the support plates or the print and drying table. Damage to the back side is therefore completely prevented.

In an embodiment of this invention, the carrier is designed to be air permeable so that the print material can be secured by the vacuum through the carrier usually applied to the print table throughout the printing operation on the print table.

In another embodiment the carrier is designed with an antistatic finish to prevent a static charge buildup during conveyance and movement over the print table. In another embodiment, the carrier is also designed to be wear-resistant so that its lifetime is long enough.

In one embodiment of this invention, the carrier may be designed to be UV-resistant and have thermal stability. Industrial cloth of any type having these properties is suitable for this intended purpose.

In a particularly advantageous embodiment of this invention, the gripper mechanism may have a pair of grippers driven by conveyor chains with the carrier held between them. The carrier is expediently connected to at least one gripper by an elastic intermediate piece capable of equalizing changes in distance between the grippers that occur during the conveyance operation.

Other objects, advantages and novel features of the present invention will become apparent from the following detailed description of the invention when considered in conjunction with the accompanying drawings.

### BRIEF DESCRIPTION OF THE DRAWINGS

FIG. 1 shows a schematic side view of a screen printing machine according to an embodiment of this invention and

FIG. 2 shows a schematic perspective partial view of the gripper system of the machine according to FIG. 1.

### DETAILED DESCRIPTION

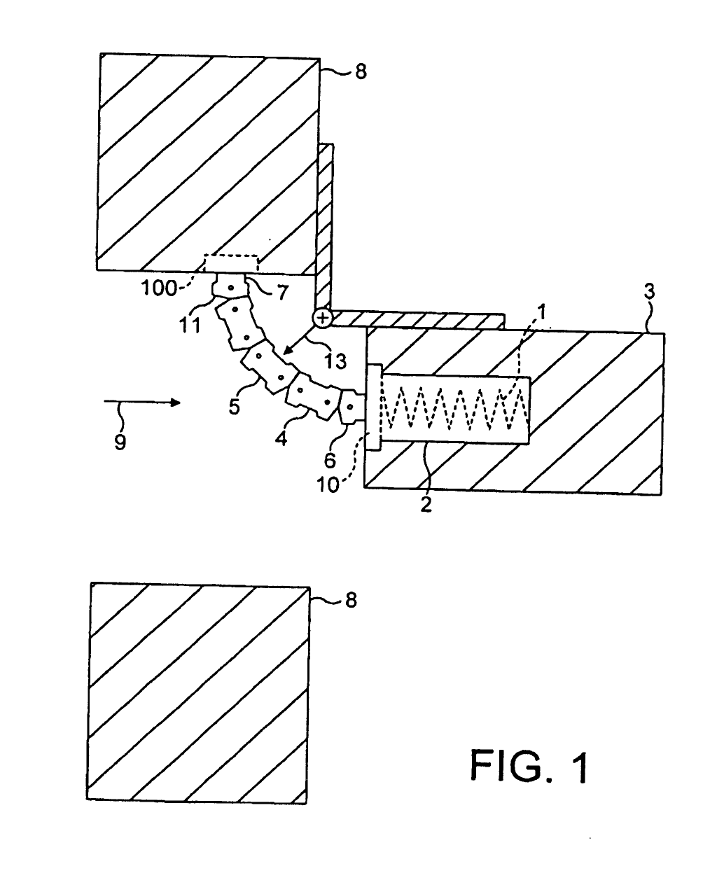

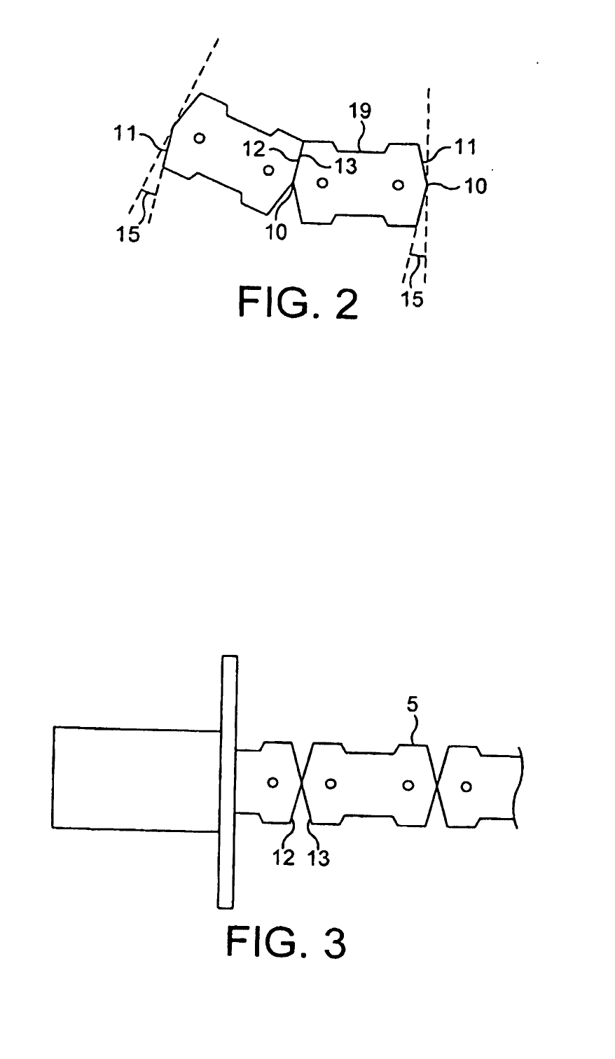

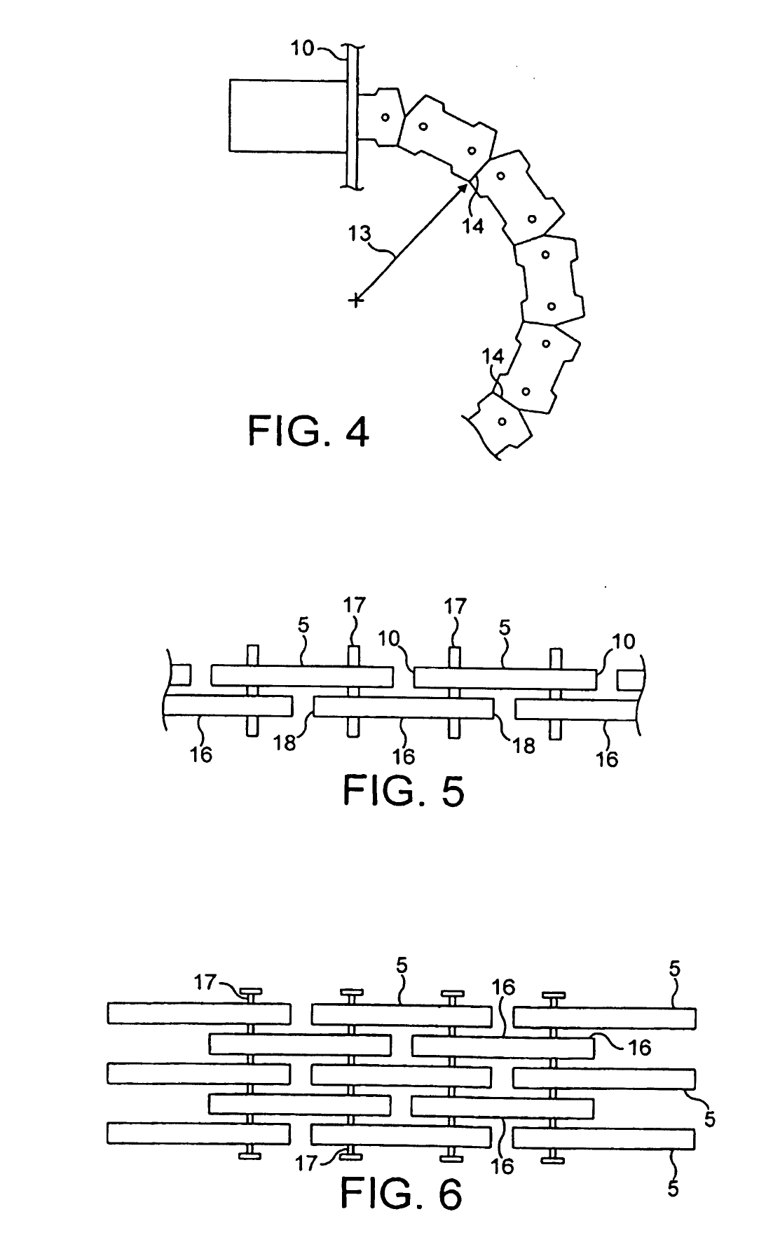

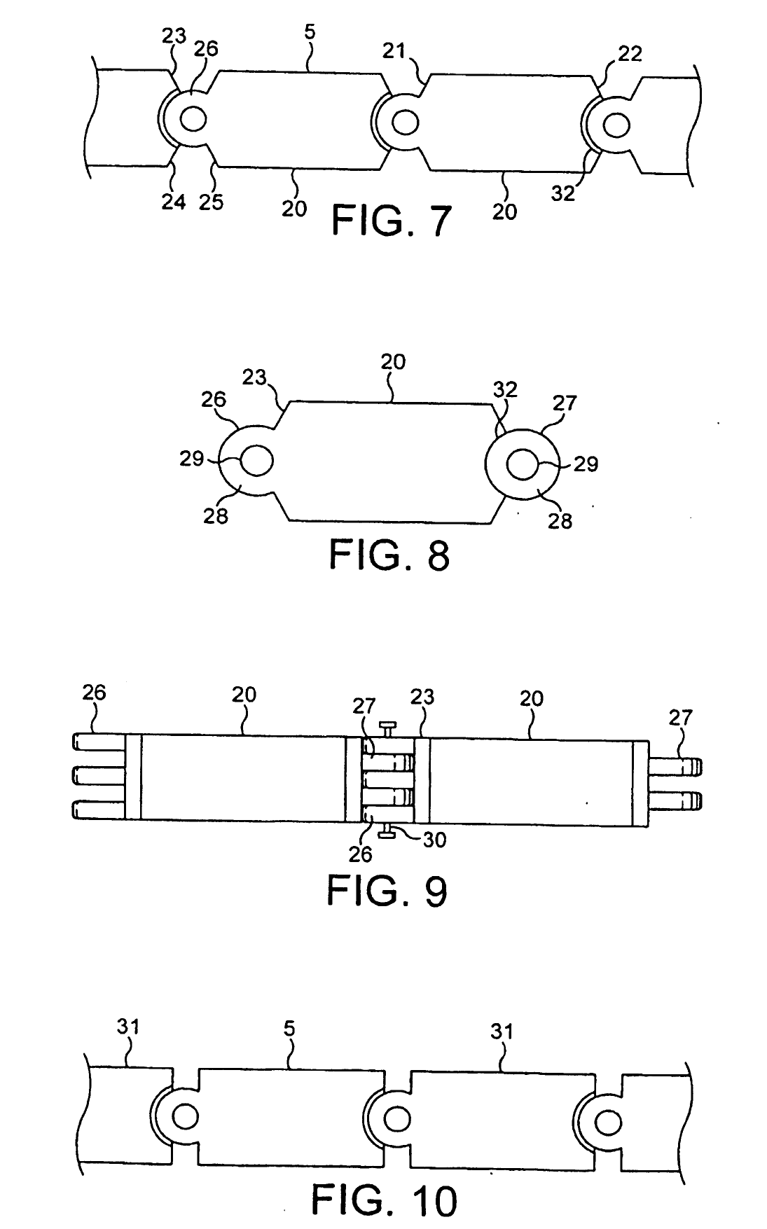

FIG. 1 shows a machine frame 1 of a screen printing machine with a print table 3 arranged below the squeegee mechanism 2, equipped with perforations 4 on its topside, as indicated schematically in FIG. 2 so that a vacuum applied to the print table can act through the perforations to hold flat print material 10 tightly on the print table during the printing operation.

In a known technology, the squeegee mechanism 2 consists of carriers 5 supported laterally above the print table, each carrier on the sides facing the other, equipped with guide rails to guide a squeegee blade 6 and a preliminary squeegee blade situated upstream in the direction of movement; each preliminary squeegee blade is mounted at both ends on a crossbeam 9 which can be moved back and forth within the carrier 5 of the squeegee mechanism and can be raised and lowered via print cylinders 7 and 8, not shown in greater detail here.

The print material 10 to be printed is gripped by a gripper from the left side with the screen printing machine shown here and fed in at the right beneath the squeegee mechanism 2 and above the print table 3. The gripper 11 is in the position beneath the squeegee mechanism 2 and on the right end of the print table 3 so that the print material 10 comes to lie above the print table. The gripper 11 is driven intermittently by conveyor chains 15 revolving clockwise in FIG. 1. The conveyor chains 15 are equipped with four grippers 11, 12, 13 and 14 which are mounted at equal distances from one another on the conveyor chains 15, each one assuming the positions shown here one after the other when the chains 15 have moved further by one segment clockwise, corresponding to the distance between two successive grippers, i.e., between the grippers 11 and 12, for example. The gripper 11 has conveyed the print material 10 over the print table 3 in the position shown here. A carrier 16 made of an industrial cloth is provided between the gripper 11 and the gripper 12 downstream from the former in the direction of movement, said carrier being connected to the two grippers 11 and 12 and similarly also to the two other grippers 12 and 13 or 13 and 14 or 14 and 11. In the exemplary embodiment, each carrier 16 is connected to at least one of the grippers; in the exemplary embodiment shown here, each carrier is connected to the downstream gripper 12 by an elastic intermediate piece 17 which can compensate for differences in distance between the revolving grippers.

This novel screen printing machine is operated in such a way that the print material 10, which is fed by the gripper 11, is printed by the movement of the squeegee mechanism. It is therefore important for the carrier 16 to be air-permeable so that the applied vacuum of the print table 3 can act through the carrier on the print material 10. However, the material of the carrier 16 should also be antistatic so that there can be no static charge buildup during the conveyance and printing operations. The carrier material is also wear-resistant and UV-resistant because it must pass through the area of the dryer where UV radiation is used.

Once the print material 10 has been printed in FIG. 1, the conveyor chain 15 continues to revolve clockwise by an amount corresponding to the distance between the grippers 11 and 12. Instead of the grippers 11, the gripper 12 is now in operation, this gripper first having gripped a new sheet of the print material in an essentially known manner and conveyed it over the print table. In this movement of the conveyor chain 15, the sheet of the print material 10 that has already been printed is conveyed by the gripper 11 beneath the squeegee mechanism 2 to the right out of the printing machine and into a position in which the print material can be dried. With each further movement of the conveyor chain 15, a new sheet for printing is conveyed over the print table. The print material 10 with this novel screen printing machine always rests on the carrier 16 and thus never comes in contact with the print table (in the area to the left of the squeegee mechanism) or a substrate (with further conveyance out of the machine to the right). Therefore, damage to the back side of the print material is completely prevented.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. Screen printing machine, comprising:
a print table:
a gripper mechanism assigned to the print table, said gripper mechanism arranged to convey print material into and out of the printing machine; and
a flexible flat carrier connected to the gripper mechanism and arranged to support print material held by the gripper mechanism.

2. Screen printing machine as claimed in claim 1, wherein the carrier is air-permeable.

3. Screen printing machine as claimed in claim 1, wherein the carrier is antistatic.

4. Screen printing machine as claimed in claim 1, wherein the carrier is wear-resistant.

5. Screen printing machine as claimed in claim 1, wherein at least a portion of the carrier supporting print material is made of cloth.

6. Screen printing machine as claimed in claim 5, wherein the cloth is UV-resistant and thermally stable.

7. Screen printing machine as claimed in claim 1, wherein the gripper mechanism has at least two grippers located on and driven by a conveyor and one carrier held between each pair of grippers.

8. Screen printing machine as claimed in claim 7, wherein the carrier is connected to at least one of the grippers by an elastic intermediate piece.

9. A method of conveying print material through a screen printing machine, comprising the steps of:
providing a screen printing machine, said printing machine including
a print table,
a plurality of gripper mechanisms assigned to the print table, said gripper mechanisms arranged to convey print material into and out of the printing machine,
at least one flexible flat carrier, each carrier connected to between two gripper mechanisms and arranged to support print material held by the gripper mechanisms, and
a conveyor on which the gripper mechanisms are carried;
gripping print material with the gripper mechanisms;
advancing the conveyor to transport the print material into the printing machine to a printing position;
further advancing the conveyor to transport the print material out of the printing machine.

10. The method of conveying print material through a screen printing machine of claim 9, wherein the at least one carrier is air-permeable, further comprising the steps of:
applying a vacuum to the at least one flat flexible carrier to fix the print material to the carrier.
